(19) United States
(12) Patent Application Publication
(10) Pub. No.: US 2001/0053005 A1
(43) Pub. Date: Dec. 20, 2001

(54) System for suppressing instabilities in an optical wavelength division multiplex ring network

(76) Inventors: Harald Bock, Augsburg (DE); Alexander Richter, Muenchen (DE); Patrick Leisching, Muenchen (DE); Detlef Stoll, Boca Raton, FL (US)

Correspondence Address: Bell, Boyd & Lloyd LLC, P.O.Box 1135, Chicago, IL, 60690, US

(21) Appl. No.: 09/801,400

(22) Filed: Mar. 7, 2001

(30) Foreign Application Priority Data
Mar. 7, 2000 (DE) 10011068.1

(51) Int. Cl. H04B 10/20; H04J 14/00; H04J 14/02

(52) U.S. Cl. 359/124; 359/119

(57) ABSTRACT

Connected into a wavelength division multiplex ring network is a filter arrangement which has a low attenuation only for the individual useful signals of the wavelength division multiplex signal and recombines these, along with launched signals to form a wavelength division multiplex signal.

### BACKGROUND OF THE INVENTION

1. Field of the Invention

The present invention relates to a system for suppressing instabilities in an optical wavelength division multiplex ring network wherein a filter arrangement is inserted in an optical conductor of the ring network, the filter arrangement having a low attenuation only for individual optical signals which are within transmission channels, and thereafter combines the useful signals with launched signals to form a wavelength division multiplex signal.

2. Description of the Prior Art

Presently, data transmission is frequently performed in optical ring networks with the aid of wavelength division multiplex technology. Particularly in the case of transparent glass fiber rings, the optical amplifiers, for example optical fiber amplifiers, lead to instabilities since the ring gain is greater than one in the case of some wavelengths outside the useful channels.

The instabilities are avoided in European Patent Application EP 0 903 882 A2 by active control, or by the use of notch filters. The high outlay control and instabilities which remain in the process, however, are disadvantageous, as is the additional outlay for the notch filters.

It is, therefore, an object of the present invention to specify a system, which is simple to implement, for avoiding instabilities in optical ring networks.

### SUMMARY OF THE INVENTION

Accordingly, in an embodiment of the present invention, a system is provided for suppressing instabilities in an optical wavelength division multiplex ring network, wherein the system includes: a first filter device inserted in an optical conductor of the ring network, the first filter having a low stop-band attenuation only for individual optical signals which are within transmission channels, and further, having a high stop-band attenuation outside the transmission channels in an entire wavelength range critical for the instabilities; and a second filter device which combines the individual optical signals with launched optical signals so as to form one wavelength division multiplex signal.

In an embodiment, both the first filter device and the second filter device are incorporated into a single module, the output of the first filter device being connected to the input of the second filter device.

In an embodiment, the first filter device has either a BULK or AWG filter structure.

In an embodiment, the first filter device is a wavelength division dimultiplexer, and the second filter device is a wavelength division multiplexer.

In an embodiment, the system is provided in a network node of the ring network.

In an embodiment, the system is provided in a network node of the ring network and is designed as an add-drop device.

In an embodiment, the entire wavelength range critical for the instabilities is at least the wavelength range of 1.53 μm to 1.565 μm.

The present invention offers the advantage in that it is possible to use filter structures which can be easily implemented and which are frequently necessary in any case for add-drop functions.

Additional features and advantages of the present invention are described in, and will be apparent from, the following Detailed Description of the Preferred Embodiments and the Drawings.

### DESCRIPTION OF THE DRAWINGS

FIG. 1 shows an optical ring network incorporating the system and the present invention;

FIG. 2 shows a variant of the system of the present invention; and

FIG. 3 shows the pass band curve of a suitable filter in accordance with the teachings of the present invention.

### DETAILED DESCRIPTION OF THE PREFERRED EMBODIMENTS

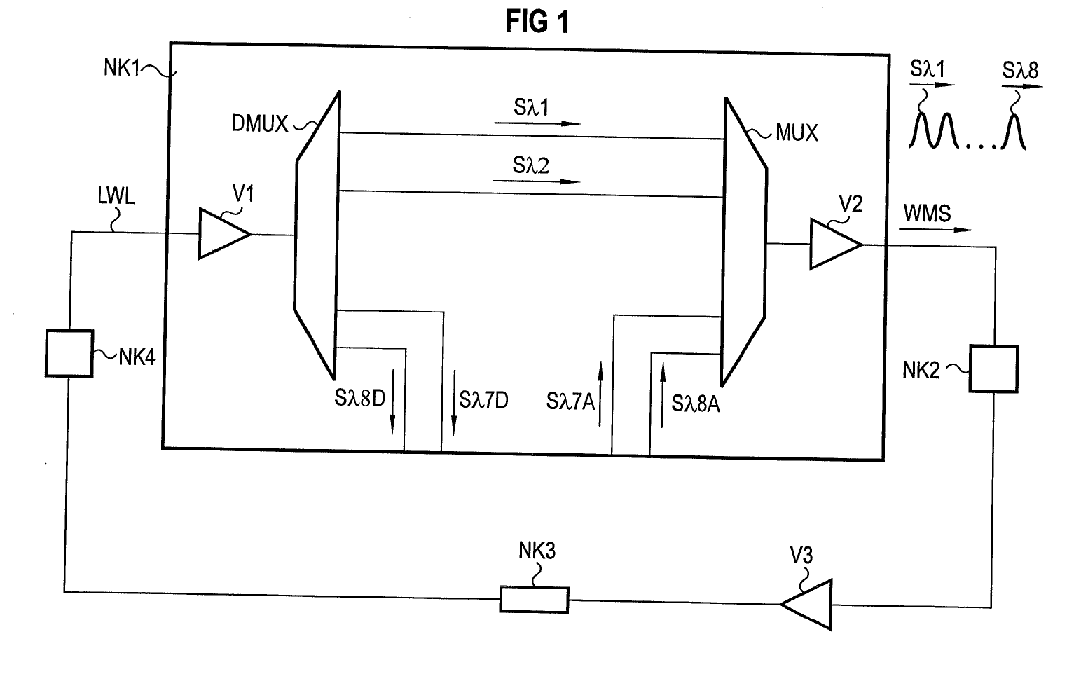

FIG. 1 shows a ring network with an optical inductor LWL and network nodes NK1, NK2, NK3 and NK4. Only the first network node NK1 is illustrated in detail to the extent it is relevant to the invention. Devices for controlling, switching over, monitoring etc., are not illustrated. Essential elements are the wavelength division demultiplexer DMUX and the wavelength division multiplexer MUX. A first optical amplifier V1 can be connected upstream of the demultiplexer DMUX, and a second optical amplifier V2 can be connected downstream of the multiplexer MUX. Moreover, further optical amplifiers V3 can be arranged between the network nodes. Various optical signals Sλ1 to Sλ7 are transmitted in a combined fashion to form a multiplex signal WMS in the ring network. Two of the signals Sλ7D (drop) and Sλ8D are extracted in the first network node NK1, and corresponding signals Sλ7A (add) and Sλ8A are launched. Other signals Sλ1 to Sλ6 are “connected through” the network node.

The wavelength division demultiplexer DMUX is designed as a filter arrangement which filters the individual optical signals out of the wavelength division multiplex signal WMS. The pass band curves of the filter arrangement determine the transmission channels. The wavelength division multiplexer MUX recombines the signals present at its inputs to form a wavelength division multiplex signal WMS. Whereas there are no stability problems in the frequency ranges of the transmission channels (the ring is interrupted by the extraction and launching), such problems arise from the amplified spontaneous emission (ASE) outside the wavelength range.

The loop gain outside the transmission channels is substantially reduced by the use of filters which have only a low pass-band attenuation for the optical useful signals Sλ1 to Sλ8 and have a very high attenuation outside the transmission band in the relevant wavelength range, so that no further instabilities occur. Such wavelength range includes at least the wavelength range of 1.53 μm to 1.565 μm. These filter properties are also denoted as an appropriately large free spectral range. The filters can be implemented as desired. Appropriate filters can be designed as AWG (arrayed waveguide) filters of high order or BULK filters (AWG filters can be obtained from Corning Cable Systems, Vertretung Optical Devices, Zielstattstrasse 40, d-81379 Munich).

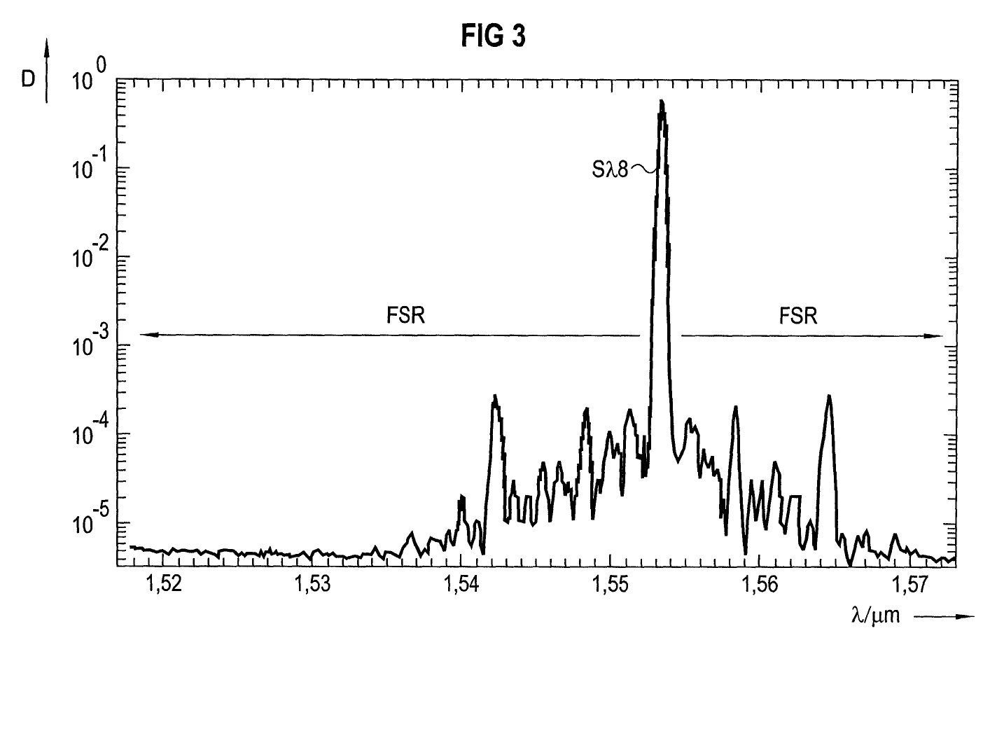

A pass-band function d of an mic filter is illustrated in FIG. 3 as a function of the wavelength λ (in micrometers). The stop band fse includes the entire relevant wavelength way. This filter is a modified littman-metcalf configuration from photonetics inc., 200 corporate place-suite 1a; peabody, Mass. 01960-5840- USA.

Apart from the wavelength ranges illustrated, the effects caused by ASE can be neglected.

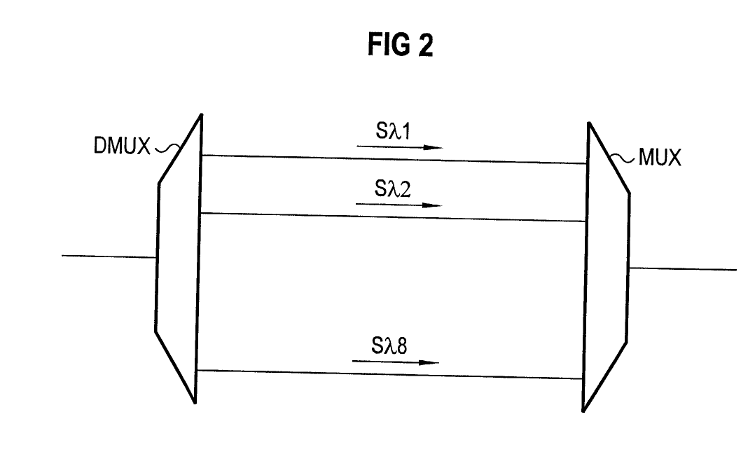

It remains to add that the wavelength division demultiplexer DMUX and the wavelength division multiplexer MUX also can be combined in a single module without possibilities for extraction or launching, as is illustrated in FIG. 2.

Any desired add-drop devices can be used with any desired filter elements in the other network nodes. This includes those which reflect the signal to be extracted and extract it via a circulator.

Although the present invention has been described with reference to specific embodiments, those of skill in the art will recognize that changes may be made thereto without departing from the spirit and scope of the invention as set forth in the hereafter appended claims.

We claim as our invention:

1. A system for suppressing instabilities in an optical wavelength division multiplex ring network, the system comprising:
a first filter device inserted in an optical conductor of the ring network, the first filter device having a low stop-band attenuation only for individual optical signals which are in transmission channels, and further having a high-band attenuation outside the transmission channels in an entire wavelength range critical for the instabilities; and
a second filter which combines the individual optical signals with, if determined to be appropriate, launched optical signals so as to form one wavelength division multiplex signal.

2. A system for suppressing instabilities in an optical wavelength division multiplex ring network as claimed in claim 1, wherein both the first filter device and the second filter device are incorporated into a single module, an output of the first filter device being connected to an input of the second filter device.

3. A system for suppressing instabilities in an optical wavelength division multiplex ring network as claimed in claim 1, wherein at least the first filter device has one of a BULK filter structure and an AWG filter structure.

4. A system for suppressing instabilities in an optical wavelength division multiplex ring network as claimed in claim 1, wherein the first filter device is a wavelength division demultiplexer, and the second filter device is a wavelength division multiplexer.

5. A system for suppressing instabilities in an optical wavelength division multiplex ring network as claimed in claim 4, wherein the system is provided in a network node of the ring network.

6. A system for suppressing instabilities in an optical wavelength division multiplex ring network as claimed in claim 4, wherein the system is provided in a network node of the ring network and is designed as an add-drop device.

7. A system for suppressing instabilities in an optical wavelength division multiplex ring network as claimed in claim 1, wherein the entire wavelength range includes at least the wavelength of 1.53 μm to 1.565 μm.
